(19) United States
(12) Patent Application Publication
(10) Pub. No.: US 2011/0107765 A1
(43) Pub. Date: May 12, 2011

(54) COUNTER ROTATED GAS TURBINE FUEL NOZZLES

(75) Inventors: Almaz Valeev, Moscow (RU); Sergey Meshkov, Moscow (RU); Garth Frederick, Greenville, SC (US); Valery Mitrofanov, Moscow (RU); Dmitry Lysenko, Moscow (RU)

(73) Assignee: GENERAL ELECTRIC COMPANY, Schenectady, NY (US)

(21) Appl. No.: 12/832,014

(22) Filed: Jul. 7, 2010

(30) Foreign Application Priority Data
Nov. 9, 2009 (RU) 2009140936

(51) Int. Cl. F02C 7/22

(52) U.S. Cl. 60/746

(57) ABSTRACT

In certain embodiments, a system includes a gas turbine controller. The gas turbine controller includes a first operational mode enabling fuel flow only through a first plurality of fuel nozzles having a first swirl direction. The gas turbine controller also includes a second operational mode enabling fuel flow only through a second plurality of fuel nozzles having a second swirl direction opposite from the first swirl direction.

### CROSS-REFERENCE TO RELATED APPLICATION

This application claims priority to and the benefit of Russian Patent Application No. 2009140936, entitled “COUNTER ROTATED GAS TURBINE FUEL NOZZLES”, filed Nov. 9, 2009, which is herein incorporated by reference in its entirety.

### BACKGROUND OF THE INVENTION

The subject matter disclosed herein relates to fuel nozzles and, more specifically, to gas turbine combustors having multiple fuel nozzles.

Gas turbines typically combust a mixture of air and fuel in a combustor to generate exhaust gases for driving a turbine and compressor section. Typical gas turbines have a limited power range, for example, by varying a quantity of fuel injection. As the quantity of fuel injection decreases, the gas turbine typically generates an increasing amount of carbon monoxide (CO) due to decreasing temperatures. In other words, exit temperatures from the combustor need to remain relatively high to ensure compliance with permitted emissions levels.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a first plurality of fuel nozzles, each including a first air passage, a first fuel passage, and a first swirl mechanism having a first swirl direction. The system also includes a second plurality of fuel nozzles, each including a second air passage, a second fuel passage, and a second swirl mechanism having a second swirl direction. The first and second plurality of fuel nozzles are arranged in an alternating annular pattern. In addition, the first and second swirl directions are opposite from one another. The system further includes a controller configured to control a first fuel flow rate through the first fuel passage and a second fuel flow rate through the second fuel passage independent from one another.

In a second embodiment, a system includes a gas turbine controller. The gas turbine controller includes a first operational mode enabling fuel flow only through a first plurality of fuel nozzles having a first swirl direction. The gas turbine controller also includes a second operational mode enabling fuel flow only through a second plurality of fuel nozzles having a second swirl direction opposite from the first swirl direction.

In a third embodiment, a system includes a controller. The controller is configured to control a first fuel flow through a first plurality of fuel nozzles having air flow swirling in a first direction. The controller is also configured to control a second fuel flow through a second plurality of fuel nozzles having air flow swirling in a second direction opposite from the first direction. The first and second fuel flows are independently controlled. In addition, the first and second plurality of fuel nozzles are arranged in an alternating annular pattern.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an embodiment of a turbine system having a combustor with a plurality of fuel nozzles;

FIG. 2 is a cross-sectional side view of an exemplary embodiment of the turbine system, as illustrated in FIG. 1;

FIG. 3 is a perspective view of a head end of a combustor of the gas turbine engine, as shown in FIG. 2, illustrating the plurality of fuel nozzles;

FIG. 4 is a cross-sectional side view of a single fuel nozzle, as shown in FIG. 3;

FIG. 5 is a perspective cutaway view of the fuel nozzle, as shown in FIG. 4;

FIG. 6 is an upstream or downstream view of the fuel nozzle configuration illustrated in FIG. 3, having five fuel nozzles in an alternating annular formation and a centrally-positioned fuel nozzle within the alternating annular formation;

FIG. 7 is an upstream or downstream view of another fuel nozzle configuration, having four fuel nozzles in an alternating annular formation and a centrally-positioned fuel nozzle within the alternating annular formation; and

FIG. 8 is an upstream or downstream view of another fuel nozzle configuration, having four fuel nozzles in an alternating annular formation without a centrally-positioned fuel nozzle.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include systems and methods for substantially reducing the amount of fuel used in a combustor of a turbine system, while still minimizing the amount of CO generated by the turbine system. In particular, the disclosed embodiments provide for arranging a first and second group of fuel nozzles, which induce swirling in opposite directions, in an alternating annular pattern such that the relative velocities of air-fuel mixtures from adjacent fuel nozzles are approximately zero. This helps reduce shear between adjacent air-fuel mixtures and also helps reduce the turbulent heat-mass exchange between adjacent fueled and unfueled flows during turndown (e.g., gradual reduction in fuel usage by the turbine system), enabling quicker CO oxidation which, in turn, reduces the amount of CO generated by the turbine system. The ability to reduce the amount of CO generated by the turbine system allows for further turndown capability. Enhanced turndown of the turbine system leads to less fuel usage during times of reduced loads without shutting down and later starting up units of the turbine system, enhancing both reliability and flexibility of the turbine system.

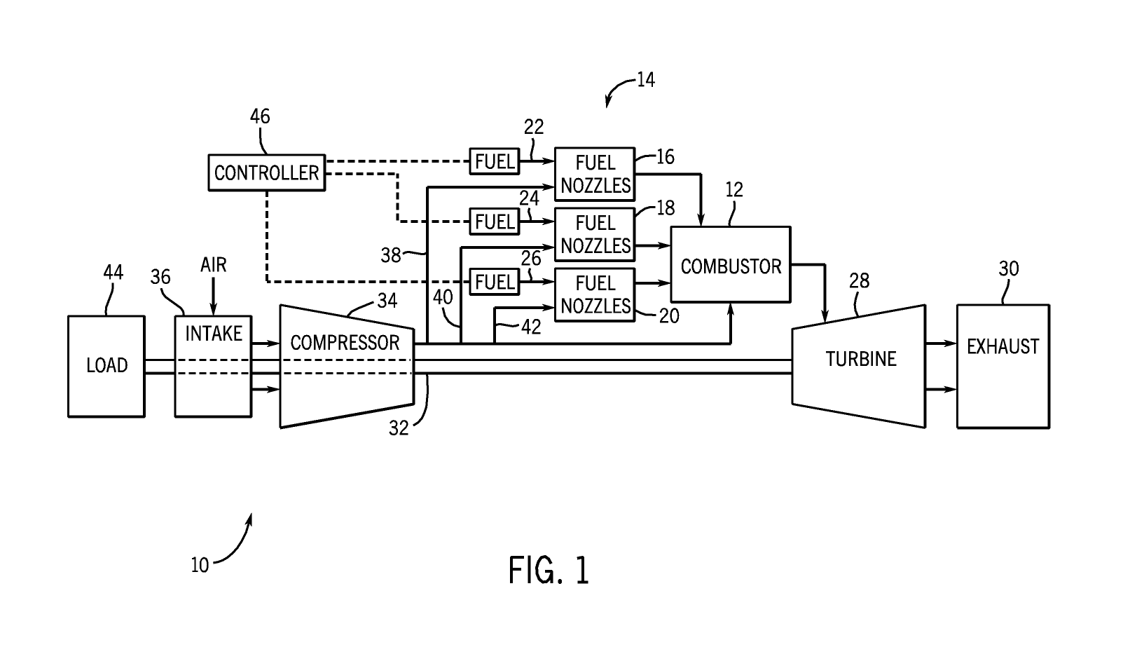

FIG. 1 is a schematic flow diagram of an embodiment of a turbine system 10 having a combustor 12 with a plurality of fuel nozzles 14. As described in greater detail below, the plurality of fuel nozzles 14 may include groups of independently-controlled fuel nozzles 14. More specifically, the plurality of independently-controlled fuel nozzles 14 may include a first, second, and third group of fuel nozzles 16, 18, 20, which may be controlled independently from each other. In addition, the first, second, and third group of fuel nozzles 16, 18, 20 may be configured to swirl in opposite directions from each other. For example, in certain embodiments, the fuel nozzles in the first group of fuel nozzles 16 may be configured to swirl an air-fuel mixture (or, in certain circumstances, only air) in a direction opposite to the fuel nozzles in the second group of fuel nozzles 18. In addition, any number of groups of fuel nozzles may be used. For example, the combustor 12 may be associated with 4, 5, 6, 7, 8, 9, 10, or more groups of fuel nozzles.

The turbine system 10 may use liquid or gas fuel, such as natural gas and/or a hydrogen rich synthetic gas. As depicted, the fuel nozzles 14 intake a plurality of fuel supply streams 22, 24, 26. More specifically, the first group of fuel nozzles 16 may intake a first fuel supply stream 22, the second group of fuel nozzles 18 may intake a second fuel supply stream 24, and the third group of fuel nozzles 20 may intake a third fuel supply stream 26. As described in greater detail below, each of the fuel supply streams 22, 24, 26 may mix with a respective air stream, and be distributed as an air-fuel mixture into the combustor 12.

The air-fuel mixture combusts in a chamber within the combustor 12, thereby creating hot pressurized exhaust gases. The combustor 12 directs the exhaust gases through a turbine 28 toward an exhaust outlet 30. As the exhaust gases pass through the turbine 28, the gases force one or more turbine blades to rotate a shaft 32 along an axis of the turbine system 10. As illustrated, the shaft 32 may be connected to various components of the turbine system 10, including a compressor 34. The compressor 34 also includes blades that may be coupled to the shaft 32. As the shaft 32 rotates, the blades within the compressor 34 also rotate, thereby compressing air from an air intake 36 through the compressor 34 and into the fuel nozzles 14 and/or combustor 12. More specifically, as described in greater detail below, a first compressed air stream 38 may be directed into the first group of fuel nozzles 16, a second compressed air stream 40 may be directed into the second group of fuel nozzles 18, and a third compressed air stream 42 may be directed into the third group of fuel nozzles 20. The shaft 32 may also be connected to a load 44, which may be a vehicle or a stationary load, such as an electrical generator in a power plant or a propeller on an aircraft, for example. The load 44 may include any suitable device capable of being powered by the rotational output of turbine system 10.

In addition, as described in greater detail below, the turbine system 10 may include a controller 46 configured to control the first, second, and third fuel supply streams 22, 24, 26 into the first, second, and third groups of fuel nozzles 16, 18, and 20, respectively. More specifically, the first, second, and third fuel supply streams 22, 24, 26 may be controlled independently from each other by the controller 46. For example, the controller 46 may be configured to control valves, pumps, and so forth upstream of the first, second, and third groups of fuel nozzles 16, 18, 20 to independently vary the first, second, and third fuel supply streams 22, 24, 26. As such, the first, second, and third fuel supply streams 22, 24, 26 and their respective first, second, and third groups of fuel nozzles 16, 18, 20 may comprise three distinct fuel supply circuits, which may be independently controlled by the controller 46. More specifically, in certain embodiments, the controller 46 may be configured to enable or disable each of the first, second, and third fuel supply streams 22, 24, 26 through the respective first, second, and third groups of fuel nozzles 16, 18, 20 to vary the total flow of fuel into the combustor 12 of the turbine system 10, enabling more flexible turndown of the turbine system 10.

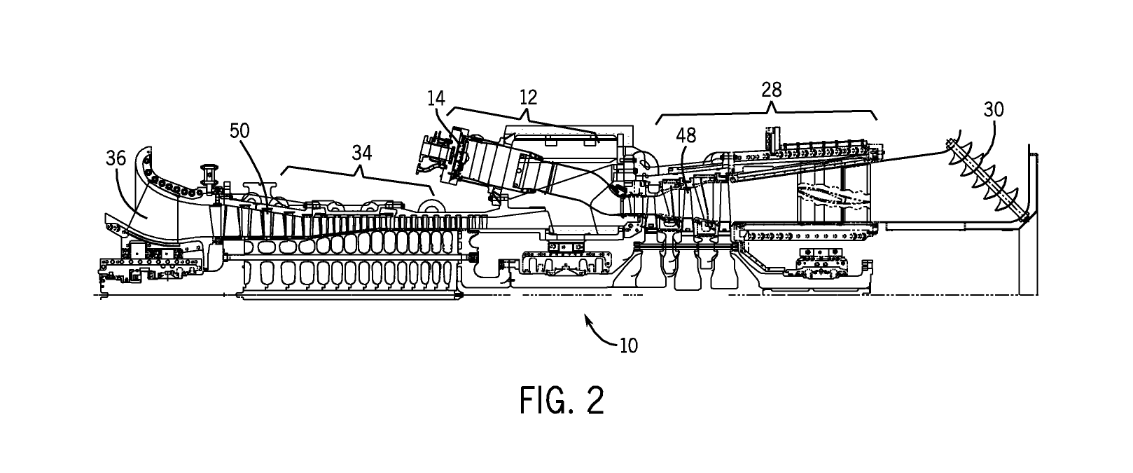

FIG. 2 is a cross-sectional side view of an exemplary embodiment of the turbine system 10, as illustrated in FIG. 1. The turbine system 10 includes one or more fuel nozzles 14 located inside one or more combustors 12. In operation, air enters the turbine system 10 through the air intake 36 and is pressurized in the compressor 34. The compressed air may then be mixed with fuel for combustion within the combustor 12. For example, the fuel nozzles 14 may inject a fuel-air mixture into the combustor 12 in a suitable ratio for optimal combustion, emissions, fuel consumption, and power output. The combustion generates hot pressurized exhaust gases, which then drive one or more blades 48 within the turbine 28 to rotate the shaft 32 and, thus, the compressor 34 and the load 44. The rotation of the turbine blades 48 causes a rotation of the shaft 32, thereby causing blades 50 within the compressor 34 to draw in and pressurize the air received by the air intake 36.

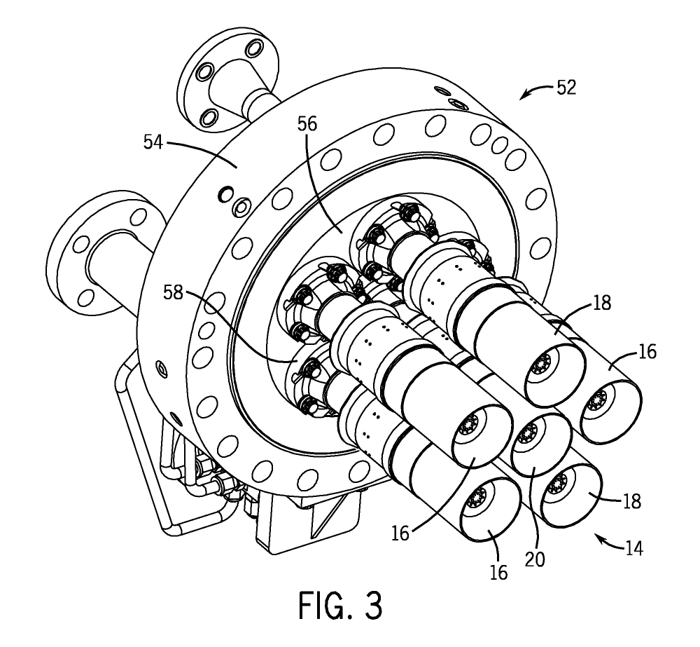

FIG. 3 is a detailed perspective view of an embodiment of a combustor head end 52 having an end cover 54 with the plurality of fuel nozzles 14 attached to an end cover base surface 56 via sealing joints 58. The head end 52 routes the compressed air from the compressor 34 and the fuel through end cover 54 to each of the fuel nozzles 14, which at least partially pre-mix the compressed air and fuel as an air-fuel mixture prior to entry into a combustion zone in the combustor 12. As discussed in greater detail below, the fuel nozzles 14 may include one or more swirl vanes configured to induce swirl in an air flow path, wherein each swirl vane includes fuel injection ports configured to inject fuel into the air flow path.

In certain embodiments, the fuel nozzles 14 include the first group of fuel nozzles 16, the second group of fuel nozzles 18, and the third group of fuel nozzles 20. In the illustrated embodiment, the first group of fuel nozzles 16 includes three fuel nozzles, the second group of fuel nozzles 18 includes two fuel nozzles, and the third group of fuel nozzles 20 includes only one fuel nozzle. As illustrated, the first group of fuel nozzles 16 and the second group of fuel nozzles 18 are disposed in an alternating annular pattern around the end cover base surface 56. In the illustrated embodiment, the third group of fuel nozzles 20 includes only one fuel nozzle, centrally positioned inside the alternating annular pattern of the first and second groups of fuel nozzles 16, 18. Therefore, the alternating annular pattern may alternate from one of the fuel nozzles of the first group of fuel nozzles 16, to one of the fuel nozzles in the second group of fuel nozzles 18, to another one of the fuel nozzles in the first group of fuel nozzles 16, and so forth, in a circumferential direction around the centrally-positioned fuel nozzle 20. As described in greater detail below, each fuel nozzle of the first group of fuel nozzles 16 may include a swirling mechanism (e.g., one or more swirl vanes) configured to induce swirl in an air-fuel mixture (or, in certain circumstances, only air) in a direction opposite to a swirling mechanism in each fuel nozzle of the second group of fuel nozzles 18.

While the first group of fuel nozzles 16 and the second group of fuel nozzles 18 are presented herein as being disposed in an alternating annular pattern, in embodiments having different numbers (e.g., one odd and one even) of fuel nozzles in the first and second groups of fuel nozzles 16, 18 (e.g., 2 and 1, 3 and 2, 4 and 3, 5 and 4, 6 and 5, 7 and 6, 8 and 7, 9 and 8, 10 and 9, 11 and 10, and so forth, respectively), two or more fuel nozzles in the same group may be disposed adjacent to each other. For example, in the embodiment illustrated in FIG. 3, two fuel nozzles of the first group of fuel nozzles 16 are disposed adjacent to each other because there is one more fuel nozzle in the first group of fuel nozzles 16 (e.g., three) than in the second group of fuel nozzles 18 (e.g., two). However, in embodiments having an identical number of fuel nozzles in the first and second groups of fuel nozzles 16, 18 (e.g., 2 and 2, 3 and 3, 4 and 4, 5 and 5, 6 and 6, 7 and 7, 8 and 8, 9 and 9, 10 and 10, and so forth, respectively), the fuel nozzles may be disposed in an alternating annular pattern around the entire circumference of the end cover base surface 56.

Furthermore, as described in greater detail below, the first, second, and third groups of fuel nozzles 16, 18, 20 may all be controlled independently from each other. For example, a first flow rate of fuel through the first group of fuel nozzles 16 may be controlled separately from a second flow rate of fuel through the second group of fuel nozzles 18, the first flow rate of fuel through the first group of fuel nozzles 16 may be controlled separately from a third flow rate of fuel through the third group of fuel nozzles 20, and the second flow rate of fuel through the second group of fuel nozzles 18 may be controlled separately from the third flow rate of fuel through the third group of fuel nozzles 20.

The ability to independently control the flow of fuel through the first, second, and third groups of fuel nozzles 16, 18, 20 may enable the total fuel flow rate into the combustor 12 to be turned down (e.g., reduced) during operation of the turbine system 10. For example, in the embodiment illustrated in FIG. 3, the total fuel flow rate may be turned down such that fuel flows from a total of six fuel nozzles 14 down to only one fuel nozzle 14. More specifically, as illustrated in Table 1, fuel may flow through all six fuel nozzles 14 at full flow when the first, second, and third group of fuel nozzles 16, 18, 20 are enabled (e.g., Mode 6). Then, the total fuel flow rate may gradually be turned down by disabling and enabling the first, second, and third group of fuel nozzles 16, 18, and 20 as summarized in Table 1 (e.g., Modes 1-5). As fuel is disabled through a given fuel nozzle 14, the compressed air from the compressor 34 may still be allowed to flow through the fuel nozzle 14. The interaction between pure air flows through certain fuel nozzles 14 and air-fuel mixtures through other fuel nozzles 14 will be described in greater detail below.

TABLE 1

| | First Group | Second Group | Third Group |
|---|---|---|---|
| | (16) (3 Fuel | (18) (2 Fuel | (20) (1 Fuel |
| | Nozzles) | Nozzles) | Nozzle) |
| Mode 6 (6 Fuel Nozzles) | Enabled | Enabled | Enabled |
| Mode 5 (5 Fuel Nozzles) | Enabled | Enabled | Disabled |
| Mode 4 (4 Fuel Nozzles) | Enabled | Disabled | Enabled |
| Mode 3 (3 Fuel Nozzles) | Enabled | Disabled | Disabled |
| Mode 2 (2 Fuel Nozzles) | Disabled | Enabled | Disabled |
| Mode 1 (1 Fuel Nozzle) | Disabled | Disabled | Enabled |

Although the illustrated embodiment depicts the first group of fuel nozzles 16 having three fuel nozzles, the second group of fuel nozzles 18 having two fuel nozzles, and the third group of fuel nozzles 20 having a single, centrally-positioned fuel nozzle, other suitable numbers and arrangements of fuel nozzles may be attached to the end cover base surface 56 via the joints 58. For example, in another embodiment, the first and second groups of fuel nozzles 16, 18 may both have two fuel nozzles, and the third group of fuel nozzles 20 may have a single, centrally-positioned fuel nozzle. Indeed, the first and second groups of fuel nozzles 16, 18 may include 1, 2, 3, 4, 5, 6, 7, 8, 9, 10, or more fuel nozzles. In general, however, the first group of fuel nozzles 16 will either have the same number of fuel nozzles as the second group of fuel nozzles 18 or will have one more fuel nozzle than the second group of fuel nozzles 18. Moreover, instead of a single, centrally-positioned fuel nozzle, the third group of fuel nozzles 20 may include 1, 2, 3, 4, 5, 6, 7, 8, 9, 10, or more fuel nozzles positioned inside the alternating annular pattern of the first and second groups of fuel nozzles 16, 18.

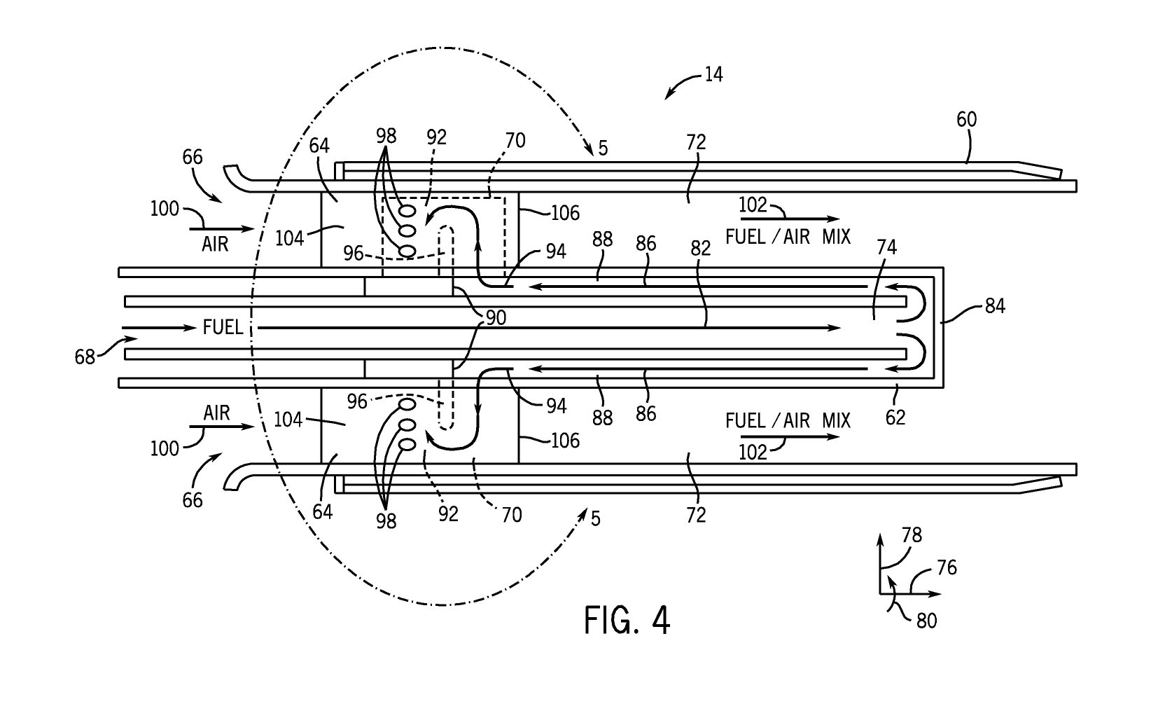

FIG. 4 is a cross-sectional side view of an embodiment of the fuel nozzle 14. In the illustrated embodiment, the fuel nozzle 14 includes an outer peripheral wall 60 and a nozzle center body 62 disposed within the outer peripheral wall 60. The outer peripheral wall 60 may be described as a burner tube, whereas the nozzle center body 62 may be described as a fuel supply tube. The fuel nozzle 14 may also include an air-fuel pre-mixer 64, an air inlet 66, a fuel inlet 68, swirl vanes 70, a mixing passage 72 (e.g., annular passage for mixing air and fuel), and a fuel passage 74. The swirl vanes 70 are configured to induce swirling flow within the fuel nozzle 14. Thus, the fuel nozzle 14 may be described as a swozzle in view of this swirl feature. It should be noted that various aspects of the fuel nozzle 14 may be described with reference to an axial direction or axis 76, a radial direction or axis 78, and a circumferential direction or axis 80. For example, the axis 76 corresponds to a longitudinal centerline or lengthwise direction, the axis 78 corresponds to a crosswise or radial direction relative to the longitudinal centerline, and the axis 80 corresponds to the circumferential direction about the longitudinal centerline.

As shown, fuel may enter the nozzle center body 62 through the fuel inlet 68 into the fuel passage 74. The fuel may travel axially 76 in a downstream direction, as noted by arrow 82, through the entire length of the nozzle center body 62 until it impinges upon an interior end wall 84 (e.g., a downstream end portion) of the fuel passage 74, whereupon the fuel reverses flow, as indicated by arrow 86, and enters a reverse flow passage 88 in an upstream axial direction. For purposes of discussion, the term downstream may represent a direction of flow of the combustion gases through the combustor 12 toward the turbine 28, whereas the term upstream may represent a direction away from or opposite to the direction of flow of the combustion gases through the combustor 12 toward the turbine 28.

At the axially 76 extending end of reverse flow passage 88 opposite end wall 84, the fuel impinges upon wall 90 (e.g., upstream end portion) and travels into an outlet chamber 92 (e.g., an upstream cavity or passage), as indicated by arrow 94. In certain embodiments, the fuel may pass around a divider 96 and into the outlet chamber 92, whereby the fuel may be expelled from the outlet chamber 92 through fuel injection ports 98 in the swirl vanes 70, where the fuel may mix with air flowing through the mixing passage 72 from the air inlet 66, as illustrated by arrow 100. For example, the fuel injection ports 98 may inject the fuel crosswise to the air flow to induce mixing. Likewise, the swirl vanes 70 induce a swirling flow of the air and fuel, thereby increasing the mixture of the air and fuel. The air-fuel mixture exits the air-fuel pre-mixer 64 and continues to mix as it flows through the mixing passage 72, as indicated by arrow 102. This continuing mixing of the air and fuel through the mixing passage 72 allows the air-fuel mixture exiting the mixing passage 72 to be substantially fully mixed when it enters the combustor 12, where the mixed air and fuel may be combusted.

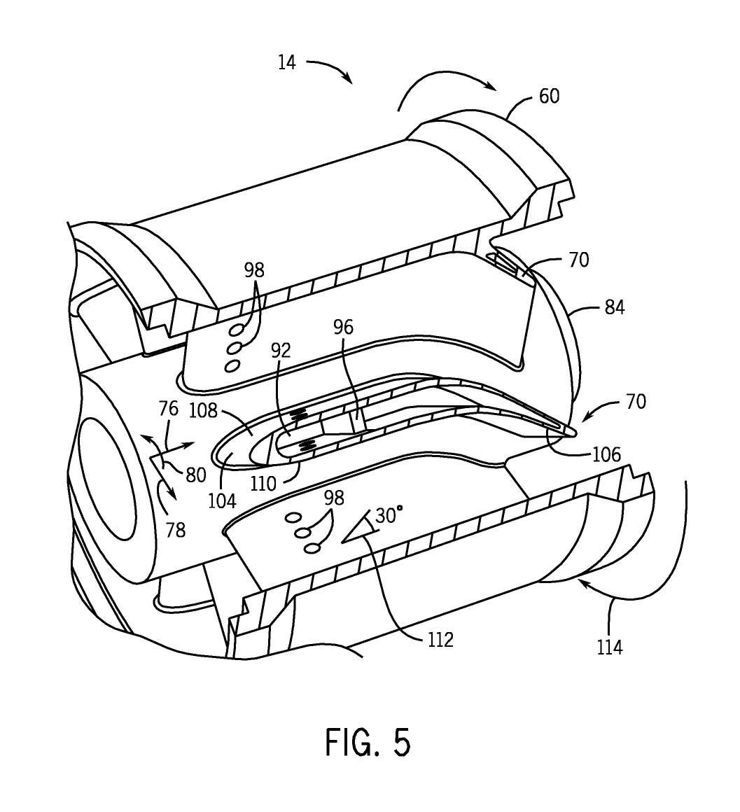

FIG. 5 is a perspective cutaway view of an embodiment of the fuel nozzle 14 taken within arcuate line 5-5 of FIG. 4. The fuel nozzle 14 includes the swirl vanes 70 disposed circumferentially around the nozzle center body 62, wherein the swirl vanes 70 extend radially outward from the nozzle center body 62 to the outer peripheral wall 60. As illustrated, each swirl vane 70 is a hollow body (e.g., a hollow airfoil shaped body) having the outlet chamber 92 and the divider 96. The fuel travels upstream in a non-linear path about the divider 96 to the outlet chamber 92, and then exits the outlet chamber 92 through the fuel injection ports 98.

The swirl vanes 70 are configured to swirl the flow, and thus induce air-fuel mixing, in a circumferential direction 80 about the axis 76. As illustrated, each swirl vane 70 bends or curves from an upstream end portion 104 to a downstream end portion 106. In particular, the upstream end portion 104 is generally oriented in an axial direction along the axis 76, whereas the downstream end portion 106 is generally angled, curved, or directed away from the axial direction along the axis 76. As a result, the downstream end portion 106 of each swirl vane 70 biases or guides the flow into a rotational path about the axis 76 (e.g., swirling flow). This swirling flow enhances air-fuel mixing within the fuel nozzle 14 prior to delivery into the combustor 12. Each swirl vane 70 may include the fuel injection ports 98 on first and/or second sides 108, 110 of the swirl vane 70. The first and second sides 108, 110 may combine to form the outer surface of the swirl vane 70. For example, the first and second sides 108, 110 may define an airfoil shaped surface, as discussed above.

Therefore, as described above, the physical shape of the swirl vanes 70 of the fuel nozzle 14 may induce swirling of the air-fuel mixture in a circumferential direction about the longitudinal centerline of the fuel nozzle 14, as indicated by arrow 114. More specifically, the downstream end portion 106 of each swirl vane 70 may bias or guide the air-fuel mixture into a rotational path about the axis 76 (e.g., swirling flow). Although illustrated in FIG. 5 as inducing counterclockwise rotational swirling relative to the axis 76, in other embodiments, the swirling vanes 70 of the fuel nozzle 14 may be designed such that clockwise rotational swirling relative to the axis 76 is induced. In fact, the embodiments illustrated in FIGS. 4 and 5 are merely exemplary of the types of swirling fuel nozzle (“swozzle”) designs that may be used and are not intended to be limiting. Other swozzle designs may be incorporated.

Indeed, as described in greater detail below, each of the fuel nozzles in the first, second, or third groups of fuel nozzles 16, 18, and 20 may be configured to swirl the air-fuel mixture in a rotational swirl direction opposite to each of the fuel nozzles in another of the first, second, or third groups of fuel nozzles 16, 18, and 20. For example, in certain embodiments, all of the fuel nozzles in the first group of fuel nozzles 16 may be configured to swirl the air-fuel mixture in a first rotational swirl direction, whereas all of the fuel nozzles in the second group of fuel nozzles 18 may be configured to swirl the air-fuel mixture in a second rotational swirl direction, wherein the first rotational swirl direction is opposite to the second rotational swirl direction.

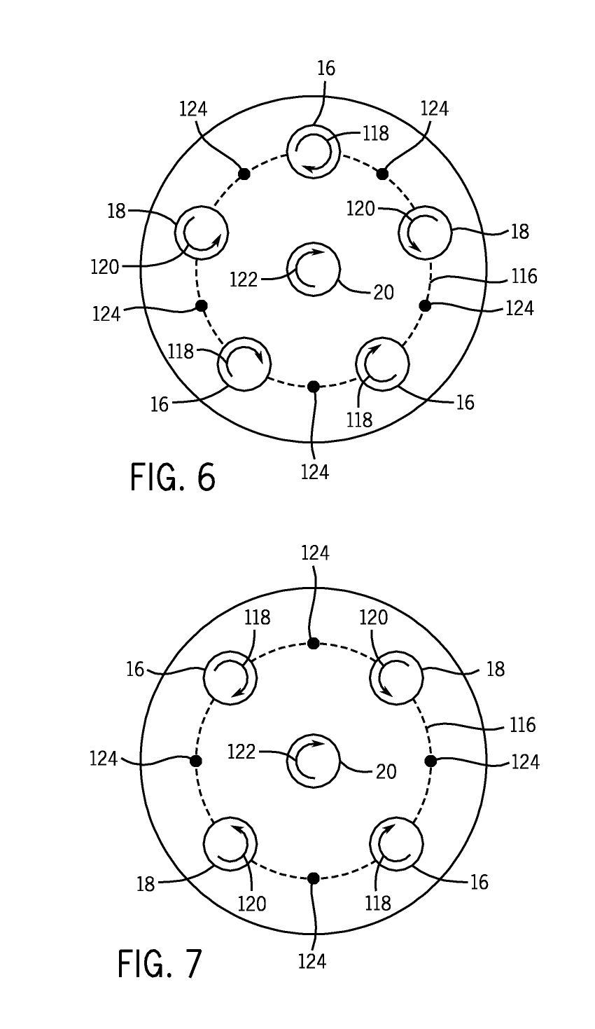

For example, FIG. 6 is an upstream or downstream view of the fuel nozzle configuration illustrated in FIG. 3. As illustrated, the first group of fuel nozzles 16 and the second group of fuel nozzles 18 are disposed in an alternating annular formation 116 (e.g., one of the fuel nozzles in the first group of fuel nozzles 16, followed by one of the fuel nozzles in the second group of fuel nozzles 18, followed by another of the fuel nozzles in the first group of fuel nozzles 16, and so forth). As described above, each of the fuel nozzles in the first group of fuel nozzles 16 may be configured to induce swirling in a first rotational swirl direction 118, whereas each of the fuel nozzles in the second group of fuel nozzles 18 may be configured to induce swirling in a second rotational swirl direction 120, wherein the first rotational swirl direction 118 is opposite to the second rotational swirl direction 120. In particular, in the embodiment illustrated in FIG. 6, each of the fuel nozzles in the first group of fuel nozzles 16 is configured to induce swirling in a clockwise rotational direction 118, whereas each of the fuel nozzles in the second group of fuel nozzles 18 is configured to induce swirling in a counterclockwise rotational direction 120.

In the illustrated embodiment, the third group of fuel nozzles 20 includes a single fuel nozzle centrally positioned within the alternating annular formation of the first and second groups of fuel nozzles 16, 18. The centrally-positioned fuel nozzle 20 may be configured to induce swirling in a third rotational swirl direction 122. In particular, in the embodiment illustrated in FIG. 6, the centrally-positioned fuel nozzle 20 is configured to induce swirling in a clockwise direction 122. As such, the centrally-positioned fuel nozzle 20 may be configured to induce swirling in the same rotational swirl direction as each of the fuel nozzles in the first group of fuel nozzles 16 and in an opposite rotational swirl direction as each of the fuel nozzles in the second group of fuel nozzles 18.

Furthermore, in certain embodiments, multiple rows of circumferentially positioned fuel nozzles may be used. For example, the fuel nozzle configuration may include 2, 3, 4, 5, 6, or more concentric rows of fuel nozzles disposed around the centrally-positioned fuel nozzle. Each row of fuel nozzles may include a first and second group of fuel nozzles 16, 18 configured in an alternating manner around the respective row. In addition, in certain embodiments, the fuel nozzles in each respective row of fuel nozzles may vary in size. For example, the centrally-positioned fuel nozzle 20 may be a different size (e.g., having different burner tube configurations, different air flows, and so forth) than the fuel nozzles in the first row of fuel nozzles illustrated in FIG. 6.

Because each of the fuel nozzles in the first group of fuel nozzles 16 induce swirling in the first rotational swirl direction 118 opposite to the second rotational swirl direction 120 induced by the second group of fuel nozzles 18, the relative velocities (i.e., the difference in velocities) of the air-fuel mixtures at a tangency point 124 (e.g., a point at which the flows of air-fuel mixtures from adjacent fuel nozzles cross paths) between each adjacent fuel nozzle in the alternating annular formation 116 may be substantially reduced. For example, by contrast, if the first and second rotational swirl directions 118, 120 of adjacent fuel nozzles were in the same direction, the relative velocities of the air-fuel mixtures at the tangency point 124 would be approximately twice the individual circumferential velocities of each air-fuel mixture, causing increased shearing and more turbulent heat-mass exchange between the adjacent air-fuel mixtures. In other words, the relative velocities would be additive (e.g., twice the shear) since the air-fuel mixtures would circulate in opposite directions at the tangency point 124. However, in the illustrated embodiment, because the first rotational swirl direction 118 is opposite to the second rotational swirl direction 120, the relative velocities of the air-fuel mixtures is approximately zero (e.g., zero shear) since the air-fuel mixtures circulate in the same direction at the tangency point 124. Similarly, because the centrally-positioned fuel nozzle 20 induces swirling in the third rotational swirl direction 122 opposite to the second rotational swirl direction 120 induced by the second group of fuel nozzles 18, the relative velocities of the air-fuel mixtures at a tangency point 124 between these fuel nozzles may also be substantially reduced.

This reduction of relative velocities of air-fuel mixtures between adjacent fuel nozzles may be particularly beneficial during turndown of the combustor 12. At lower loads of the turbine system 10, fewer fuel nozzles may be enabled (e.g., have fuel flowing through them). For example, Modes 2-4 described above are scenarios where either the first group of fuel nozzles 16 or the second group of fuel nozzles 18 are disabled (e.g., not having fuel flowing through them). During these disabled modes, flames from the enabled (e.g., fueled) group of fuel nozzles interact with only quenching air from the disabled (e.g., unfueled) group of fuel nozzles. For example, assuming that the embodiment illustrated in FIG. 6 is being operated in Mode 4, the first and third groups of fuel nozzles 16, 20 may be fueled, while the second group of fuel nozzles 18 may be unfueled. As such, flames from the first and third groups of fuel nozzles 16, 20 may interact with only quenching air from the second group of fuel nozzles 18.

Therefore, with minor modifications (e.g., opposite direction of swirl) to the swirling vanes 70 of the fuel nozzles for one of the groups of fuel nozzles (e.g., the second group of fuel nozzles 18 in the embodiment illustrated in FIG. 6), the effect of shear and turbulent heat-mass exchange between adjacent fuel nozzles may be substantially reduced. This may enable quicker CO oxidation in the air-fuel mixture delivered to the combustor 12 of the turbine system 10, allowing for increased turndown capabilities, for example, all the way down to Mode 1, described above. As such, less fuel may be used during low-load periods and the need for shutting down and starting up units of the turbine system 10 may be reduced.

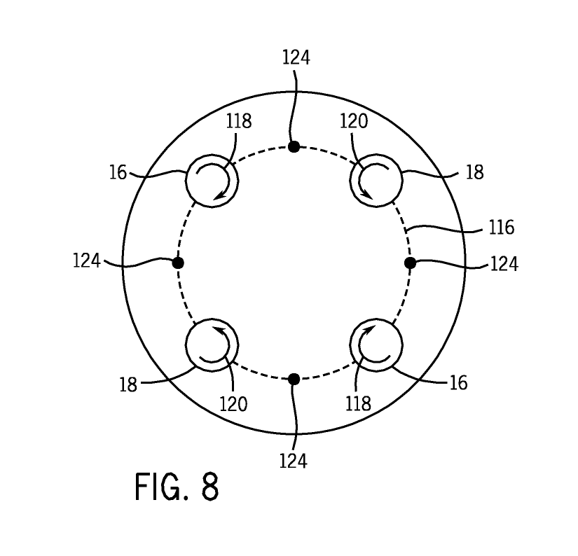

As described above, the embodiment illustrated in FIG. 6 is not the only configuration of fuel nozzles that may be used. For example, FIGS. 7 and 8 illustrate two other exemplary configurations of fuel nozzles. In the embodiments illustrated in both FIGS. 7 and 8, the first group of fuel nozzles 16 and the second group of fuel nozzles 18 are disposed in the alternating annular formation 116 and each group has two fuel nozzles. Again, each of the fuel nozzles in the first group of fuel nozzles 16 may be configured to induce swirling in the first rotational swirl direction 118, whereas each of the fuel nozzles in the second group of fuel nozzles 18 may be configured to induce swirling in the second rotational swirl direction 120, wherein the first rotational swirl direction 118 is opposite to the second rotational swirl direction 120. The main difference between the two embodiments illustrated in FIGS. 7 and 8 is that only the embodiment illustrated in FIG. 7 includes a centrally-positioned fuel nozzle 20 within the alternating annular formation 116.

Moreover, the two additional embodiments illustrated in FIGS. 7 and 8 are not the only other configurations of fuel nozzles that may be used. For example, as described above, the first and second groups of fuel nozzles 16, 18 may include 1, 2, 3, 4, 5, 6, 7, 8, 9, 10, or more fuel nozzles. In general, however, the first group of fuel nozzles 16 will either have the same number of fuel nozzles as the second group of fuel nozzles 18 or will have one more fuel nozzle than the second group of fuel nozzles 18. Moreover, instead of a single, centrally-positioned fuel nozzle, the third group of fuel nozzles 20 may include 1, 2, 3, 4, 5, 6, 7, 8, 9, 10, or more fuel nozzles positioned inside the alternating annular formation of the first and second groups of fuel nozzles 16, 18. In addition, as illustrated in FIG. 8, any of the embodiments may have no third group of fuel nozzles 20.

Technical effects of the disclosed embodiments include providing systems and methods for turning down (e.g., reducing) the amount of total fuel flow through a plurality of fuel nozzles of the combustor 12 of the turbine system 10 while minimizing the amount of CO generated by the turbine system 10 during combustion of the fuel within the combustor 12. In particular, as described above, first and second groups of fuel nozzles 16, 18 may be arranged in an alternating annular formation such that relative velocities of air-fuel mixtures from adjacent fuel nozzles are substantially minimized.

As described above, the controller 46 may be configured to independently control the amount of fuel into the first, second, and third groups of fuel nozzles 16, 18, and 20, respectively, by controlling valves, pumps, and so forth upstream of the first, second, and third groups of fuel nozzles 16, 18, 20. As such, the first, second, and third groups of fuel nozzles 16, 18, 20 may comprise three distinct fuel supply circuits, which may be independently controlled by the controller 46. More specifically, as described above, the controller 46 may be configured to enable or disable fuel flow through the first, second, and third groups of fuel nozzles 16, 18, 20 to vary the total flow of fuel into the combustor 12 of the turbine system 10, enabling more flexible turndown of the turbine system 10. The controller 46 may, in certain embodiments, be a physical computing device specifically configured to control valves, pumps, and so forth upstream of the first, second, and third groups of fuel nozzles 16, 18, 20. More specifically, the controller 46 may include input/output (I/O) devices for determining how to control the control valves, pumps, and so forth. In addition, in certain embodiments, the controller 46 may also include storage media for storing historical data, theoretical performance curves, and so forth.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a first plurality of fuel nozzles, each comprising a first air passage, a first fuel passage, and a first swirl mechanism having a first swirl direction;
a second plurality of fuel nozzles, each comprising a second air passage, a second fuel passage, and a second swirl mechanism having a second swirl direction, wherein the first and second plurality of fuel nozzles are arranged in an alternating annular pattern, and the first and second swirl directions are opposite from one another; and
a controller configured to control a first fuel flow rate through the first fuel passage and a second fuel flow rate through the second fuel passage independent from one another.

2. The system of claim 1, wherein the controller comprises a first operational mode enabling the first and second fuel flow rates through the first and second fuel passages, wherein the first operational mode allows airflow through the first and second air passages.

3. The system of claim 2, wherein the controller comprises a second operational mode disabling the first fuel flow rate through the first fuel passage, wherein the second operational mode allows airflow through the first and second air passages, and the second operational mode allows the second fuel flow rate through the second fuel passage.

4. The system of claim 3, wherein the controller comprises a third operational mode disabling the second fuel flow rate through the second fuel passage, wherein the third operational mode allows airflow through the first and second air passages, the third operational mode allows the first fuel flow rate through the first fuel passage, and the first and second plurality of fuel nozzles have a different number of fuel nozzles.

5. The system of claim 4, wherein the first plurality of fuel nozzles comprises an even number of fuel nozzles, and the second plurality of fuel nozzles comprises an odd number of fuel nozzles.

6. The system of claim 1, comprising a center fuel nozzle disposed at a central position inside the alternating annular pattern, wherein the center fuel nozzle comprises a third air passage, a third fuel passage, and a third swirl mechanism having a third swirl direction, and wherein the controller is configured to control a third fuel flow rate through the third fuel passage independent from the first and second fuel flow rates through the first and second fuel passages.

7. The system of claim 6, wherein the controller comprises a first operational mode enabling the first, second, and third fuel flow rates, a second operational mode enabling the third fuel flow rate and disabling the first and second fuel flow rates, and a third operational mode enabling the first fuel flow rate and disabling at least the second fuel flow rate.

8. The system of claim 6, wherein the first plurality of fuel nozzles has only three fuel nozzles, the second plurality of fuel nozzles has only two fuel nozzles, and the center fuel nozzle has only one fuel nozzle.

9. The system of claim 1, wherein the first swirl mechanism comprises a first swirl vane disposed in the first air passage, and the second swirl mechanism comprises a second swirl vane disposed in the second air passage.

10. The system of claim 9, wherein the first swirl vane comprises a first fuel port coupled to the first fuel passage, and the second swirl vane comprises a second fuel port coupled to the second fuel passage.

11. The system of claim 1, wherein the first and second plurality of fuel nozzles are disposed in a plurality of alternating annular patterns, wherein the plurality of alternating annular patterns are concentric with each other.

12. The system of claim 11, wherein the fuel nozzles disposed in each alternating annular pattern are sized differently.

13. A system, comprising:
a gas turbine controller, comprising:
a first operational mode enabling fuel flow only through a first plurality of fuel nozzles having a first swirl direction; and
a second operational mode enabling fuel flow only through a second plurality of fuel nozzles having a second swirl direction opposite from the first swirl direction.

14. The system of claim 13, wherein the first and second operational modes enable air flow through the first and second plurality of fuel nozzles.

15. The system of claim 14, wherein the first and second plurality of fuel nozzles are arranged in an alternating annular pattern.

16. The system of claim 13, comprising a third operational mode enabling fuel flow only through a third fuel nozzle.

17. The system of claim 16, comprising a fourth operational mode enabling fuel flow only through the first and second plurality of fuel nozzles, and a fifth operational mode enabling fuel flow through the first and second plurality of fuel nozzles and the third fuel nozzle.

18. A system, comprising:
a controller configured to:
control a first fuel flow through a first plurality of fuel nozzles having air flow swirling in a first direction; and
control a second fuel flow through a second plurality of fuel nozzles having air flow swirling in a second direction opposite from the first direction, wherein the first and second fuel flows are independently controlled, and wherein the first and second plurality of fuel nozzles are arranged in an alternating annular pattern.

19. The system of claim 18, wherein the controller is configured to control a third fuel flow through a central nozzle having air flow swirling in a third direction, wherein the first, second, and third fuel flows are independently controlled, and wherein the central nozzle is disposed at a central position inside the alternating annular pattern.

20. The system of claim 18, wherein the controller is configured to control the first fuel flow through the first plurality of fuel nozzles by controlling the first fuel flow through only three fuel nozzles, and wherein the controller is configured to control the second fuel flow through the second plurality of fuel nozzles by controlling the second fuel flow through only two fuel nozzles.
